(19) United States
(12) Patent Application Publication
(10) Pub. No.: US 2010/0313391 A1
(43) Pub. Date: Dec. 16, 2010

(54) HOOK LOCK WITH CLICK SOUND

(76) Inventor: Hakan Bergkvist, Bromma (SE)

Correspondence Address: JACOBSON HOLMAN PLLC, 400 SEVENTH STREET N.W., SUITE 600, WASHINGTON, DC, 20004, US

(21) Appl. No.: 12/449,433

(22) PCT Filed: Feb. 6, 2008
(86) PCT No.: PCT/SE2008/000102

§ 371 Date: Aug. 7, 2009

(30) Foreign Application Priority Data
Feb. 12, 2007 (SE) 0700337-9

(51) Int. Cl. A44B 13/00; F16B 45/00

(52) U.S. Cl. 24/598.4

(57) ABSTRACT

A hook lock comprises a first locking part (10) comprising ring-shaped element and a second locking part (20) that is provided with a gripping body and a hook finger (22) that can be inserted into the ring element (10), the second locking part having a manually actuatable retaining tongue that extends generally parallel to and in a direction opposite the hook finger (22), the retaining tongue (30), at the free end thereof, having a stopper that engages against a retaining surface (41) of a retaining nose (40), which in the brought together state of the locking parts is situated on the side of the ring element facing the retaining tongue (30), the retaining tongue being turningly biased against the retaining nose. The second locking part (20) carries an arm that extends generally parallel to the retaining tongue (30). The free end (51) of the arm is situated in order to, upon the separation of the locking parts (10, 20), pass over the retaining nose (40). The arm is elastically biased toward the hook finger (22). The arm, which when bringing together the locking parts is turned away from the hook finger (22) by the co-operation with the retaining nose (40), strikes audibly against the first locking part, when the two locking parts come into full engagement with each other.

The invention relates to a hook lock of the kind that is defined in the preamble of claim 1.

Thus, the invention relates to a hook lock of the general kind disclosed in SE-C2-516108.

Such previously known hook locks are particularly suitable for baby carriers of the kind that also is disclosed in, among others, SE-C2-516108.

Such baby carriers comprises a baby carrier that is worn by a user's upper body and that carries a front piece the lower central part of which is connected to the baby carrier and the upper lateral side portions of which are detachably connected to a respective chest strap of the baby carrier by means of a hook lock of the kind outlined above herein. Such a hook lock comprises a first locking part in the form of a ring, preferably an elongate vertically orientated ring, and a second locking part, which carries a hook finger that is directed downward to be received in the first locking part. The second locking part may then carry an upper lateral side part of the front piece of the baby carrier. The second locking part comprises a gripping body that the user can grip with the hand in order to manoeuvre with the finger. Furthermore, the second part is provided with a support tongue that is turnable toward and away from the body and that is carried by the gripping body and extends generally in a direction that is opposite parallel to the longitudinal direction of the hook finger. The retaining tongue has a retaining stopper in the vicinity of the free end thereof, the retaining stopper engaging under a retaining nose on the side of the ring facing the retaining tongue. The retaining tongue is elastically biased to a position in which it engages under the retaining nose when the retaining hook of the second part fully engages into the ring of the first part. With one of the hands, the user can grip over the gripping body, and the retaining tongue is bent away from the retaining position thereof so that the second locking part can be unhooked from the first locking part. The retaining mechanism is automatically activated by the bias of the retaining tongue when the two locking parts are brought into full engagement with each other.

The user of such a hook lock generally wants to have a confirmation of the hook finger coming into full engagement in the ring, which is of particularly interest in connection with baby carriers.

It is true that a hook lock of the previously known kind occasionally emits an audible sound when the locking parts are brought into full engagement. The sound arises, if the retaining/manoeuvre tongue is left free, so that it under the impact of the spring bias thereof is driven quickly against the first locking part when the retaining tongue passes the retaining nose. However, there is a problem in that the user of the hook lock often holds the retaining tongue of the second locking part pressed against the gripping body when putting down the hook finger in the first locking part, whereby no click sound appears until possibly when the retaining tongue is released quickly (and provided that the locking parts are in full engagement with each other).

An object of the invention is to provide a hook lock by means of which an acoustic indication clearly and always is obtained when the second locking part has been inserted fully into the first locking part, even if the user urges the retaining tongue against the gripping body when bringing together the second locking part with the first locking part. An additional object of the invention is to provide a particularly favourable embodiment.

The objects are entirely or partly attained by the invention. The invention is defined in the appended independent claim.

Embodiments of the invention are defined in the appended dependent claims.

In the following, an embodiment of the invention will be described by way of examples, reference being made to the appended drawing.

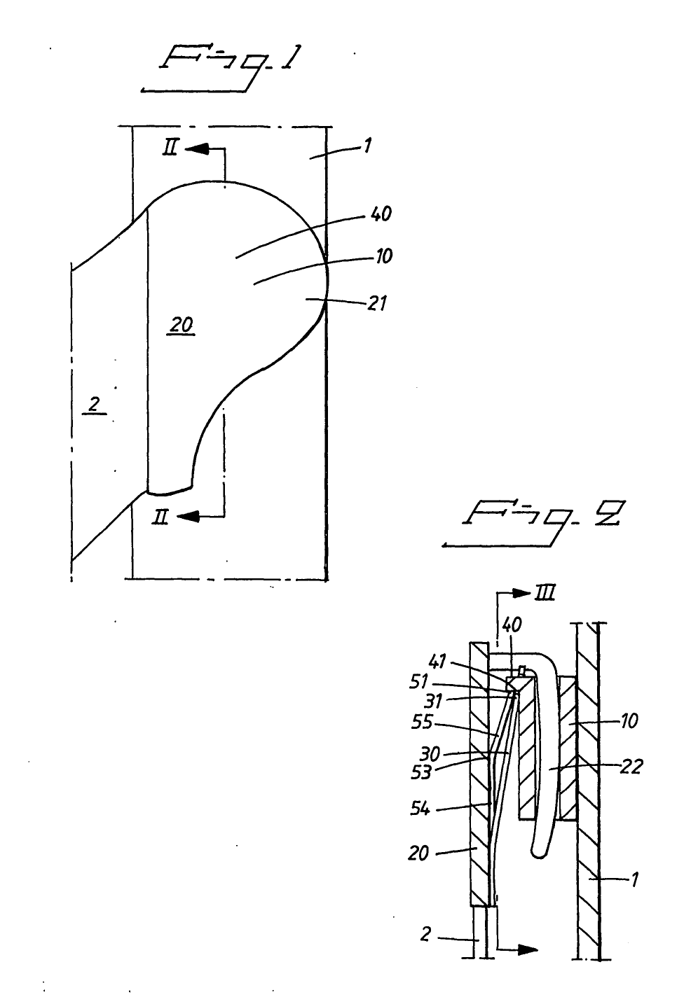

FIG. 1 schematically shows a view of a hook lock.

FIG. 2 schematically shows a section taken along the line II-II in FIG. 1, through a hook lock according to the invention.

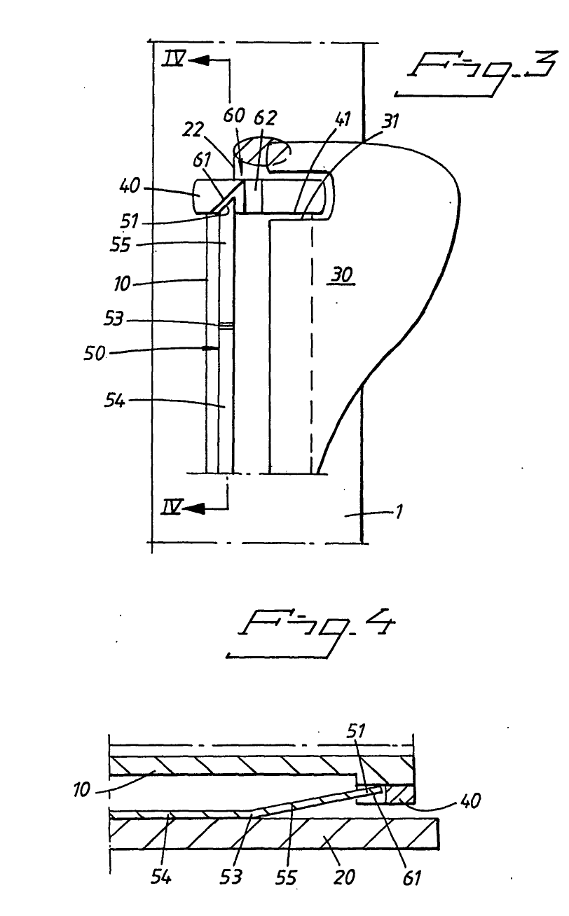

FIG. 3 shows a schematic sectioned view taken along the line in FIG. 2.

FIG. 4 illustrates a schematic section taken along the line IV-IV in FIG. 3.

In FIG. 2, a vertically orientated chest strap 1 belonging to a baby carrier is schematically shown, and a first locking part 10 in the form of a vertically orientated piece of pipe, which receives a vertically downwardly directed hook finger 22 arranged on a second locking part 20 that has a gripping body 21, which is shown connected to a lateral upper end part of a front piece 2 belonging to a baby carrier. The gripping body 21 projects laterally from the finger 22 in order to be easily grippable by the hand, for lifting off the locking part 20 from the tubular/sleeve-shaped first locking part 10. At the lower part thereof, the locking part 20 carries a retaining tongue 30 that is elastically biased toward the sleeve part 10. In the fully brought-together state of the hook lock, for instance illustrated in FIG. 2, an upwardly turned end edge 31 on the arm 30 engages with a downwardly turned retaining surface 41 of a retaining nose 40, which is located on the sleeve 10 side facing the gripping body 20, 21. When the finger 22 is brought down from above into the sleeve 10, the arm 30 will first be forced in toward the locking part 20, and when the finger 22 is fully brought down into the sleeve 10, the arm 30 will turn out into engagement position with the nose 40, such as is shown in FIG. 2. In that connection, an acoustic click signal is occasionally obtained, indicating that the locking parts 10, 20 are in a correct locking engagement with each other. But the retaining arm 30 should, for natural reasons, have a planar extension that essentially corresponds to the one of the gripping body 21 and will therefore often, by the hand of the user, be held squeezed against the gripping body 21 at the connection of the locking part 20 to the locking part 10. As is particularly seen in FIG. 3 and FIG. 2, the locking part 20 carries an arm 50 that is directed essentially parallel to the finger 22 and has the lower end thereof connected to the lower portion of the locking part 20, the upper end part 51 of the arm 50 being situated immediately under the retaining nose 40. The arm 50 is biased so that it abuts against the sleeve 10 and has the upper end thereof arranged and placed such that, when lifting off the locking part 20 from the locking part 10 (the retaining tongue 30 having to be folded back by the user, away from engagement with the retaining surface 41), the free arm end 51 can ride over the retaining nose 40 and accordingly cannot obstruct the lifting off of the locking part 20 from the sleeve 10. When the locking part 20 subsequently is coupled to the locking part 10 and the finger 22 comes into full engagement position in the sleeve 10, the arm 50 slides off from the retaining nose 40 and is driven by the spring bias thereof into acoustically audible contact with the sleeve 10, and this independently of whether the user of the hook lock still holds the retaining tongue 30 turned against the gripping body 21. By means of this acoustic signal, the user becomes assured that the hook finger 22 of the hook lock has been brought into full engagement with the sleeve 10.

In a special embodiment, the retaining nose 40 has, on the side thereof facing the body 21, a notch 60 one side wall 61 of which extends at an oblique angle to the longitudinal direction of the sleeve 10. The free end 51 of the arm 50, which is guided into said notch, is thereby laterally deflected, in the plane of the plate-shaped gripping tongue 21, and at the upper end of the notch, i.e., at the upper edge of the nose 40, the arm 50 may leave the notch and spring back laterally toward the strain-free direction thereof. The opposite wall 62 of the notch may slope laterally upward from the triangular bottom of the notch, away from the first wall 61 in order to, upon contact with the laterally diverted arm, lift the same upward from the bottom of the notch. Alternatively or in addition, the arm 50 may, in the longitudinally central area thereof, be bent so that it, when the outer free arm part 55 slides over the retaining nose 40 upon the separation of the locking parts 10, 20, abuts against and rests against the gripping body 21, the lower arm part 54 between the attachment point of the arm 50 and the bent portion 53 running along a path at a distance from the notch, so that, upon the separation of the locking parts 10, 20, the arm 50 can spring back laterally, so that the arm runs on the outside of the retaining nose 40 over the area of the first oblique wall 61. As an alternative thereto, such as has been indicated above, the second wall 62 of the notch may have an inclination that allows the arm 50 to be lifted up out of the notch so that the arm can spring back laterally after the front end part 51 of the arm having passed the retaining nose 40. The end 51 of the arm 50 is shown to be obliquely cut off parallel to the first wall 61, and the end 51 of the arm 50 is situated close by the wall surface 61 in the brought-together state of the parts 10, 20 to abruptly be able to strike against the bottom surface of the notch that is situated between the walls 61, 62 and that is parallel to the surface of the arm 50 facing the same.

The baby carrier, a chest strap 1, a front piece 2 and the locking parts 10, 20 of which are shown in FIG. 1, may, for instance, be of the design type disclosed in WO 01/84984 A1.

1. Hook lock comprising a first locking part (10) comprising a ring-shaped element and a second locking part (20) that is provided with a gripping body (21) and a hook finger (22) that can be inserted into the ring element (10), the second locking part having a manually actuatable retaining tongue (30) that extends generally parallel to and in a direction opposite the hook finger (22), the retaining tongue (30), at the free end thereof, having a stopper (31) that engages against a retaining surface (41) of a retaining nose (40), which in the brought-together state of the locking parts is situated on the side of the ring-shaped element (10) facing the retaining tongue (30), the retaining tongue being turningly biased against the retaining nose (40), characterized in that the second locking part (20) carries an arm (50) that extends generally parallel to the retaining tongue (30), that the free end (51) of the arm (50) is situated in order to, upon the separation of the locking parts (10, 20), pass over the retaining nose (40), that the arm (50) is elastically biased toward the hook finger (22), and that the arm (50), which when bringing together the locking parts is arranged to be turned away from the hook finger (22) by the co-operation with the retaining nose (40), is arranged to clear the retaining nose (40) and to audibly strike against the first locking part, when the two locking parts come into full engagement with each other.

2. Hook lock according to claim 1, characterized in that the retaining nose (40) has a notch (60) that, upon the separation of the locking parts (10, 20), co-operates with the arm (50) and has a first wall (61) that is oblique in relation to the longitudinal axis of the ring element (10) and, upon contact with the free end of the arm (50), deflects the same laterally, perpendicularly to the deflection direction of the arm from the hook finger.

3. Hook lock according to claim 2, characterized in that the notch (60) has a second wall (62) that is opposite the first wall (61) and slopes upward from the bottom of the notch in the direction away from the first wall to allow the arm (50) to be lifted from the bottom of the notch.

4. Hook lock according to claim 3, characterized in that the second wall (62) is arranged to substantially entirely lift up the arm out of the notch upon the separation of the locking parts in order to allow the arm to laterally, under the impact of the bias thereof, turn back to a position above the first oblique wall (61), and that the end of the arm (50) is situated close by the first oblique wall (61) when the locking parts (10, 20) are fully brought-together so that the arm end (51) audibly, under the impact of the diversion thereof produced by the retaining nose, can strike against the bottom of the notch, when the locking parts reach the entirely brought-together position thereof.

5. Hook lock according to claim 2, characterized in that the end of the arm has an oblique end surface essentially parallel to the first wall (61).

6. Hook lock according to claim 2, characterized in that the arm (50) has a bend in the longitudinally central area thereof, the arm resting with a bent portion (53) against the gripping body (21) when bringing together the locking parts (10, 20), the arm part between the bent portion and the attachment point of the arm having such an extension that it runs without contacting the retaining nose, whereby the part of the arm situated between the bent portion and the arm attachment point clears from engagement with the notch, when the arm part (54) situated between the bent portion and the arm attachment point runs out through the notch, whereby the arm is allowed to spring back laterally so that it, when bringing together the locking parts (10, 20), can run over the upper edge of the first notch wall (61) in the final phase of the bringing together of the locking parts (10, 20), the arm end (51) abruptly and audibly striking against the bottom surface of the notch.

7. Hook lock according to claim 2, characterized in that the oblique wall's edge, along which the laterally diverted arm (50) runs, is parallel to the bias direction of the arm toward the element (10) and is parallel to the side surface of the arm (50) abutting there against.

8. Hook lock according to claim 2, characterized in that the arm (50) has a substantially rectangular cross-section.
